(19) United States
(12) Patent Application Publication
(10) Pub. No.: US 2021/0319515 A1
(43) Pub. Date: Oct. 14, 2021

(54) System and Process For Displaying Calculated Long Term Growth Of A Financial Account

(71) Applicant: Troutwood, LLC, Pittsburgh, PA (US)

(72) Inventors: Eugene M. Natali, JR., Pittsburgh, PA (US); Jeffrey Richard Davidek, Pittsburgh, PA (US); Dorian Brown, Pittsburgh, PA (US)

(73) Assignee: Troutwood, LLC, Pittsburgh, PA (US)

(21) Appl. No.: 17/230,465

(22) Filed: Apr. 14, 2021

Related U.S. Application Data
(60) Provisional application No. 63/009,844, filed on Apr. 14, 2020.

(51) Int. Cl. G06Q 40/06; G06Q 10/06; G06F 30/20; G09B 19/18; G09B 5/02; G09B 5/06; G06F 3/0484

(52) U.S. Cl. CPC G06Q 40/06; G06Q 10/067; G06F 30/20; G06F 3/04847; G09B 5/02; G09B 5/06; G09B 19/18

(57) ABSTRACT

An investment learning system is provided having a single general user interface; and
a computer connected to the single general user interface and having:
   a computer readable storage device having a database module for collecting, storing, and linking data associated with historical financial performance data of a market fund;
   a central processing unit connected to the single general user interface and the computer readable storage device, and running a plurality of core modules to display a progression of at least one of account values, graphics, audible or text feedback representing the financial performance of a user simulated account through a simulation, the plurality of core modules used to perform the simulation include:
      a user contribution selection module for setting an initial amount to invest in the simulated account in numerical value, and a periodic contribution amount to invest in the simulated account in numerical value;
      a time frame module configured to set a length of time period represented in the simulation; and
      a data display module configured to present a graphical representation of the progression indicative of the financial performance of the simulated account with respect to the initial amount, the periodic contribution amount, and the length of time period.

### CROSS-REFERENCE TO RELATED APPLICATION

This application claims the benefit of U.S. Provisional Patent Application No. 63/009,844, filed on Apr. 14, 2020.

### FIELD OF INVENTION

This disclosure relates to financial investment education and, more particularly, to financial investment education by providing an investment learning system for modelling and simulating the benefits of long term investment behavior, and providing feedback to the user encouraging long term mindset in investment behavior, even in light of a simulated crisis event.

### BACKGROUND

Approximately 115 million Americans do not invest. Basic education teaching investment “know how” is greatly lacking, and traditional pension fund availability is sharply declining a trend likely to persist. Whereas retirement has historically been “employer directed” it is quickly becoming “employee directed”. There is no greater need within financial education than preparing individuals for this changing retirement landscape. Financial challenges to the general population are numerous, including a student loan crisis, which continues to grow. Corporations and even municipal and state governments are freezing or eliminating their pension plans. The minimum age for Social Security eligibility has risen and may continue to rise. This cumulative reduction of the United States retirement safety net is an issue of national importance. The demand and need to help Americans, particularly young Americans, develop viable plans to achieve financial stability is very high. What is needed is a system that will help users develop viable plans, provide modelling of financial outputs in response to entered variables, and optionally provides for a financial simulation activity that may be utilized as part of an education curriculum, or for investor education programs. Such a system may beneficially provide users with a better understanding of the impact of financial decisions and life choices, and provide positive reinforcement and communication to help users implement, maintain, and successfully realize those financial plans and goals.

Further, many young adults fail to appreciate the need for long-term investing, withdraw after losses, or are intimidated of the process. As a result, many young professionals fail to invest at all, or fail to continue investing early in their professional careers. In some instances, long term investors will emotionally react to adverse, near term events in the overall marketplace and sell without concern about the impact on long term goals. The early years of an investment life cycle, paired with less investment know-how at this stage, results in individuals being most prone to making mistakes and pulling investments or failing to continuing investing, especially when viewed in the light of their remaining human capital and theoretical ability to continue contributing to their investment portfolio for many years to come. The institutional investment model applied by many pension funds, is an example of the validity to individuals also staying the course and maintaining a long-term focus.

Therefore, there is a need to demonstrate the value of long-term investing, even when faced with adverse short-term conditions that have occurred frequently over the course of all prior career cycles and a long term investment terms.

### SUMMARY

Accordingly, a system and process for teaching the benefits of long term investing, by simulating long term investment results based on user provided assumption, according to the invention is provided to educate the user on investment growth by simulating performance through long term investment periods. The system does this by displaying simulated trends using historical data, and engaging the user, a non-investor, to better understand the value and benefits of investing.

The system identifies a critical deterrent to individuals choosing not to invest, adverse financial conditions known as corrections, recessions and far less often, depressions. Preparing individuals in advance for the possibility of losing ½ there money in the near term, simultaneously prepares them to stick with the predetermined objective.

In an exemplary embodiment, there is provided an investment learning system, comprising having single general user interface; and a computer connected to the single general user interface and having: 1) a computer readable storage device having a database module for collecting, storing, and linking data associated with historical financial performance data of a market fund; 2) a central processing unit connected to the single general user interface and the computer readable storage device, and running a plurality of core modules to display a progression of at least one of account values, graphics, audible or text feedback representing the financial performance of a user simulated account through a simulation, the plurality of core modules used to perform the simulation include: 1) a user contribution selection module for setting an initial amount to invest in the simulated account in numerical value, and a periodic contribution amount to invest in the simulated account in numerical value; 2) a time frame module configured to set a length of time period represented in the simulation; and 3) a data display module configured to present a graphical representation of the progression indicative of the financial performance of the simulated account with respect to the initial amount, the periodic contribution amount, and the length of time period.

In some embodiments, the plurality of core modules may also have a data aggregator for collecting data of the initial amount value; collecting data of the periodic contribution value; and collecting data of the length of time of the simulation; and aggregating the data and applying historical financial performance data to perform the simulation.

In some embodiments, the plurality of core modules may also have a graphical conversion module providing a graphical form to display the progression, graphics, or text feedback representing the financial performance of the user simulated account during the simulation.

In an exemplary embodiment, the simulation includes at least one financial crisis event characterized by a negative event in the historical financial performance data for at least a portion of the simulation. The negative event may be caused to occur within an initial period of the simulation, which may be selected from at least one of an initial three simulated years of the simulation.

In an exemplary embodiment, the negative event produces a visual negative feedback in the form a red warning display, a warning sound being audibly detected, and a warning message indicating the negative performance of the account.

In an exemplary embodiment, at least a portion of the progression, graphics, audible or text feedback representing the financial performance of the user simulated account during a simulation includes a positive feedback, which may be at least one of displaying green on the display, a celebratory sound being audibly detected, and a congratulatory message concerning the positive performance of the account.

### BRIEF DESCRIPTION OF THE DRAWING(S)

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic diagram of hardware infrastructure for an investment learning system according to the invention;

FIG. 2 is a schematic diagram of an investment learning system according to the invention;

FIG. 3 is a flow chart of exemplary action elements selectable by the user, for an investment learning system according to the invention; and

FIGS. 4-7 are exemplary images of the graphical user interface and examples of the service modules necessary for performing the tasks of the investment learning module, according to exemplary embodiments of the invention.

### DETAILED DESCRIPTION OF THE EMBODIMENT(S)

Embodiments of the present invention will be described hereinafter in detail with reference to the attached drawings, wherein like reference numerals refer to the like elements. The present invention may, however, be embodied in many different forms and should not be construed as being limited to the embodiments set forth herein; rather, these embodiments are provided so that the disclosure will be thorough and complete and will fully convey the concept of the invention to those skilled in the art.

Other systems, methods, features and advantages of the invention will be or will become apparent to one with skill in the art upon examination of the following figures and detailed description.

In an embodiment, the teachings herein described a system and process that allows a user to simulate crisis events through a custom investment period utilizing relevant data and user controlled inputs, as variables in the software. In an embodiment, the present invention relates to an investment learning system to simulate financial performance of a hypothetical investment strategy, triggers a financial crisis within the simulation, and graphically displays the progress and final results of the simulation, by digitally presenting and displaying the simulated changes in value of a simulated investment account. More particularly the investment learning system provides an investment learning module that has one or more of a user contribution selection module 120, a timeframe selection module 125, a data aggregator module 130, a graphical conversion module 135, and a data display module 140, as will be discussed. The investment learning system 1 provides systems and methods, and utilizes algorithms for displaying account value changes (delta), whether as increases or decreases in a simulated financial account, using the entries provided by the user for starting contribution amount, regular contribution amount, and timeframe for the simulation, and utilizing historical returns from a market investment fund. The investment learning system provides the user feedback on a simulated financial crisis occurring during the simulated period, which can have short-term impact on the simulated account, and demonstrates the effect of long-term investment approach along with continuing contributions on the simulated account. The feedback may be in one or more of graphical and numerical form, provided on a personal computer or mobile device display, utilizing at least one of software and data networks for generating the user feedback via the display.

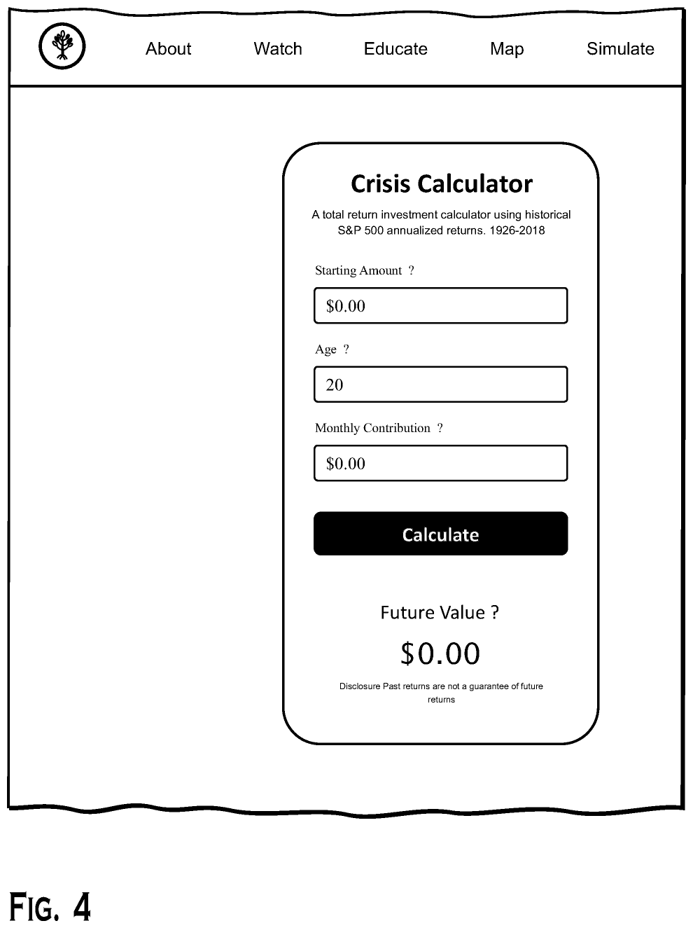

In an exemplary embodiment of the invention, the system and processes for transforming and displaying long term investment information through simulated financial crisis events is performed using an investment learning system through an app or web based calculator tool, for example, as shown in FIGS. 4-7, as will be discussed. The investment learning system employs software and hardware.

Now with reference to the figures, an exemplary embodiment is further described.

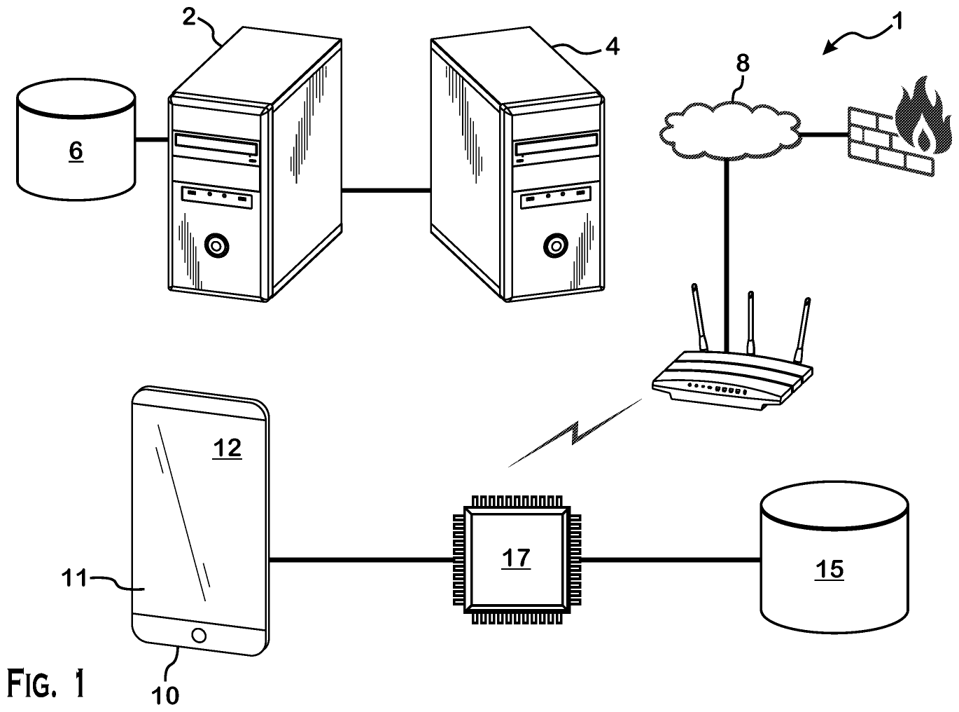

Referring first to FIG. 1, hardware infrastructure for an embodiment of the investment learning system 1 will be described. To perform the aforementioned and other functions, the investment learning system 1 generally includes a plurality of integrated system servers 2, 4 with one or more databases 6 (i.e., internal information repository), a network interface 8 accessible through various known communication protocols, such as TCP/IP, cellular protocols including GSM, Wi-Fi, Wi-Max, or other wireless communications technologies or combination of wired or wireless channels, network security devices (where necessary), and a computing device 10 having a processing unit 17 and memory 15.

The investment learning system 1 allows a user to access to a plurality of system files that includes data, such as information and images, through the computing device 10 and a network traffic information on the database server 4 (i.e. SQLServer or PostgreSQL (also known as Postgres) or newer) that connects to a web server 6. The web server 4 functions as a way for network interface 8 to communicate to the database server 2 through known application-programming interface (API) between the computing device 10 and the database server 4. A firewall may be used for security purposes such as, but is not limited to, blocking unauthorized access to the web server 6 and permitting unauthorized communication thereto. The investment learning system 1 is designed to run through the computing device 10 through an investment learning system module that can be downloaded over personal area networks (PANs), local area networks (LANs), campus area networks (CANs), wide area networks (WANs), metropolitan area networks (MANs) and any new networking system developed in the future. One skilled in the art should appreciate that the investment learning system 1 can be maintained solely through the computing device 10, as the investment learning system modules can be pre-loaded to the computing device 10. The computing device as depicted having a processor 17 for performing the necessary calculations and performing the actions for the investment learning module having a plurality of service modules within the investment learning module, and also having memory 15, configured for storing and accessing the investment learning system files, including market return data and formulas that may be employed in the investment learning simulation. In the shown embodiment, the user may connect to the network interface 8 using the computing device 10 through the router for instance. One skilled in the art would appreciate that other hardware and protocol designs are possible as long as such modifications would not divert from the spirit of the invention.

In an exemplary embodiment, as shown in FIG. 1, the computing device 10 generally includes a general user interface 12, a memory device 15, and a processor 17. In the shown embodiment, the computing device is a tablet computer or mobile phone with a touchscreen display 11. The touchscreen display 11 uses finger or stylus gestures to navigate the general user interface (GUI) 12. However, one skilled in the art should appreciate that other implements could be used; including a computer mouse, a keyboard, or joystick. In fact, one skilled in the art should appreciate that the computing device 10 is a physical computer and could be, but not limited to, a desktop computer, a laptop computer, or a cell phone, and utilize a downloaded app or web browser. The memory device 15 is a storage device having computer components and recording media used to retain digital data. The processor 17 is a central processing unit (CPU) that manipulates data stored in the memory device by performing computations. In an alternative embodiment, the investment learning system files, including market return data and formulas, and programming language necessary for performing the simulation may be loaded into the memory device 15 of the computing device 10, and performable by the processor 17, utilizing user inputs through the interface 11, as will be described. In such an embodiment, there may be no need for communication through the network interface 8 to communicate with external devices (e.g. servers 2, 4) through a network router.

In an embodiment, the investment learning system 1 is configured to provide a financial simulation for the user, after the user has entered initial parameters, such as information regarding the amount to be invested initially, and amounts to be regularly contributed to a hypothetical account, along with a time frame (e.g. number of years) for the simulation. The simulation then utilizes historical market return data, including at least one financial crisis entry (e.g., recession, depression) that triggers a partial loss of investment account, provides feedback to the user concerning the amount lost, and also the feedback provides encouragement to the user, as the simulation then demonstrates the results of a long term investment strategy with ongoing contributions, and with growth far exceeding the amount lost over the course of the simulation. The investment learning system 1 thus demonstrates to the user that even in light of a loss of invested amounts, the long-term strategy and ongoing contributions will result in growth of the simulated account. In this manner, the investment learning system, through the simulation operation provides experience to a user, and demonstrates the importance of maintaining the practice of investing, and not halting contributions, when faced with even a significant loss (e.g., 50% loss) due to a simulated financial crisis during the simulation, as the majority of historical returns are positive, and will far exceed the lost amount during the course of the simulation.

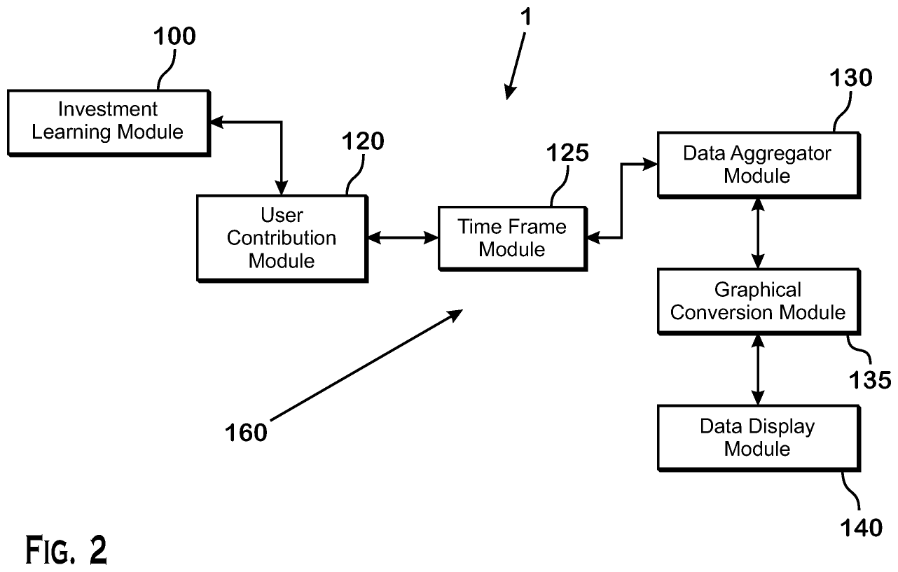

Now with reference to FIG. 2, the investment learning system 1 will be described. The investment learning system 1 includes an investment learning module 100, having a plurality of service modules 160, including: a user contribution selections module 120, a time frame selection module 125, a data aggregator module 130, a graphical conversion module 135, and a data display module 140. The investment learning system has an investment learning module 100 and further relies on actions carried out by a plurality of service modules 160 helpful for carrying out various aspects of the invention, as will be described.

User Contribution Selection Module

The user contribution selections module 120 allows the user to select an initial amount to invest in the simulation, and further the user may select an amount to contribute on a simulated periodic basis within the simulation.

The initial amount to be entered by the user may be any non-negative numerical value. The initial amount may also be referred to as the “starting amount”. In an embodiment, the initial amount is to be a currency amount, such as dollar amount, though one may substitute alternative currencies for use in alternative locations. The initial amount may be utilized in the simulation to create a hypothetical user investment account that is to be invested in a stock market fund. In an embodiment, the user may select which market to invest in, for which the system would have access to historical market return data for the relevant markets the user may elect to invest in. In an embodiment, the initial amounts is the dollar amount with which the user will begin investing in the S&P 500, with relevant historical returns for the S&P 500 provided for use within the simulation.

Additionally, within the user contribution selection module, the user enters an amount for periodic contributions within the simulation to the simulated investment account. The periodic contribution value entered is to be any non-negative numerical value, in the same currency as the initial amount that is to be invested, and represents an amount to be invested within the simulation for each recurring period during the relevant time frame being simulated, as will be discussed. The periodic contributions may be any suitable periodic frequency, such as daily, weekly, monthly, bi-monthly, quarterly, annually, for which the selected periodic contribution amount may be simulated for the duration of the simulation. In an embodiment, the user is asked to make a monthly contribution, which is to be invested into the same account as the initial contribution amount. In an embodiment, the periodic contribution is a monthly contribution to be made as investments into the S&P 500.

Time Frame Module 125

The time frame module 125 allows the user to define the length of time being simulated within the simulation. In an exemplary embodiment of the time frame module 125, the user enters, for the commencement of the simulation, an initial age, where the simulation will run for a simulated period of time equivalent to 70 years minus the initially supplied user age. Thus the simulation is to simulate a period of time during which the hypothetical user would age from the initially supplied age, until achieving 70 years of age. It is contemplated that an alternative end to the simulation may be triggered by achieving a different simulated age, such as 65 years old, or any other age so desired. In an embodiment, the user may be asked to provide a target year for retirement, and calculate the duration of the simulation by subtracting the initial age entry from the target retirement year entry, with the resulting difference being utilized as the duration of the simulation.

In an alternative embodiment of the time frame module 125, the user may be asked to define a period of time for the simulation, typically by entering a value for a number of years. In this embodiment, the simulation allows the user to directly determine the period of time being simulated. The period of time value to be entered by the user may be any non-negative numerical value that the user wishes to simulate. In an embodiment, the user may determine a desired age for retirement, and subtract the user's current age to arrive at a suitable value for use in the simulation.

In any embodiment, the defined period of time for the simulation is determinative of the number of defined periodic contributions within the simulation. For example, where the period of time for the simulation is to be 35 years, and the periodic contributions are to be monthly, the number of periodic contributions would be 35 years multiplied by 12 monthly contributions. One skilled in the art would understand to adjust the calculation for alternative periodic contributions, such as daily, weekly, bi-weekly, quarterly, or yearly periodic contributions.

Data Aggregator Module 130

The data aggregator module 130 is initiated when the user selects the icon “calculate” on the interface. The data aggregator module 130 will then utilize the user entries described previously, and access the database containing the historical returns to apply in the simulation, as well as perform the necessary calculations for performing the simulation. In an embodiment, the data aggregator module 130 would determine the number of periodic contributions, utilizing the user entry from the time frame module 125 to determine the number of years to be simulated, and then multiplying the number of periodic contributions per year by the number of years in the simulation.

The historical returns accessed from the database, or alternatively stored within the memory 15 of the user computing device 10, such as a computer, tablet, or mobile phone, as appropriate, may be accessed for use in performing the necessary calculations for the simulation. In an embodiment, the historical returns utilized in the simulation are modeled after a scenario where there is an initial decline or financial crisis, for example, by declining 50% from the initial amount invested value provided by the user, subsequently the balance of the years of the simulation may utilize an average annual return that is representative of the average annual return of the market fund vehicle that is the subject of the simulation. Alternatively, the simulation may, after the initial decline of the initial starting investment, may apply a set of historical returns from the database, which may be applied in consecutive or random order for the balance of the simulation.

The data aggregator module 130 would utilize a compound interest formula as would be familiar to those of skill in the art. Such compound interest formula would be applied for the number of years selected, with an initial investment amount, and a periodic contribution according to the user contribution selections module 120. With such parameters, and access to historical rate information, the data aggregator module 130 runs the necessary calculations for the simulation, to provide an output that models the financial behavior of the simulated account.

In an alternative embodiment of the data aggregator module 130, the simulation will perform a custom stress test, and models the percentage decline for a time period of 1 year, or multiple years, by year. In such an embodiment, the user may be asked to provide a length of time, and depth (in percentage terms) of the crisis to be modeled within the simulation. The user can select if the years having negative growth number more than one, and may select the number of years that are associated with negative growth. Furthermore, the user may select if the years are congruent (being of similar rates of negative growth), and/or consecutive, or non-consecutive, such as by being scattered through the duration of the simulation. For example, the user may opt to model a crisis occurring during years 10-12 of the simulation, with returns of −15%, −22%, and −8%. The user may determine which years, and to what extent the growth rates are negative for the crisis. In an embodiment, the user may select from system provided scenarios, that are identified as moderate, severe, disastrous levels of crisis, and observe that a long term investment mindset, accompanied by continued contributions for the course of the simulation would be expected to provide growth within the simulated account, even in light of applying one of the crisis scenarios within the simulation.

In another embodiment of the data aggregator module 130, the user may elect to have the system model a historic crisis, using market returns for each of the years of the simulation according to historical information in consecutive order as they occurred. For example, the user may elect to model or stress test an investment strategy that includes an actual challenge to the stock market, such as the great depression, or great recession resulting from the housing market bubble burst. In this manner, the user can see the effect of investing long term, even in the face of challenges to the investment strategy.

Graphical Conversion Module 135

The graphical conversion module 135, utilizes the information generated from the data aggregator module 130, causes the processor 17 to prepare a graphical representation that can be displayed during the simulation, and will be caused to be displayed by the data display module 140, as will be discussed. The graphical conversion module 135 is to provide a representation of the performance of the investment account within the simulation, and will be caused to be altered during the course of the simulation.

For example, the initial loss of 50%, in an embodiment, where there is a crisis in year one of the simulation, would be caused to display on the screen with a message of negative feedback to the user, and may be associated with a red trim, or have a portion of the display flash red, and optionally provide a message to the user. For example, the message of “OH NO! You lose ½ your money in year 1.” may be caused to be displayed on the display. Furthermore, the message may additionally offer encouragement to the user to maintain the long term investing strategy, such as by displaying a message of “Don't worry, you'll get over it” optionally with a positive feedback emoji or graphic to be displayed. This negative feedback occurs during the course of the simulation being presented to the user, and is immediately followed by the account demonstrating growth over the balance of the simulation. In this manner, the user experiences the negative results being compensated for by future growth of the account.

In an embodiment, the graphical conversion module 135 provides a digital counter display that scrolls through varying amounts as the simulation is run. Thus there may be displayed a dollar amount where the counter rolls from $0.00, and increases to the amount set by the user for the initial contribution amount, e.g., $1,000, or any other non-negative amount set by the user. The simulation, as it is run for each simulated year, would be reflected in revisions to the counter displayed on the interface. For example, in a simulation scenario where the crisis causes a 50% loss of the account value, the counter would be shown to roll downwards, decreasing from the exemplary $1000, down to $500, along with the presentation of negative feedback described above. Continuing with the simulation however, as the amount of the simulated account increases to reflect positive growth, the counter would reflect an increased value, and optionally, at least a portion of the display will be caused to display green, indicative of positive growth, in contrast to negative growth rates that would cause the display of red on at least a portion of the screen. The counter at the end of the simulation would reflect the total simulated account value, including initial investment, contributions, and growth.

The graphical conversion module 135 would be tasked with preparing the information that would be displayed to the user, according to the data display module 140 below.

Data Display Module 140

The data display module 140 utilizes the information from the data aggregator module 130, and according to the information from the graphical conversion module 135, directs the appropriate graphic display to the digital display 11 of the computing device 10, such as computer, tablet, or mobile phone.

In an embodiment, the data display module 140 is configured to present the simulated financial performance on the computing device 10 of the user, thereby providing visual feedback in the form of one or more of digital graphic, graphics, animation, or animations, as will be discussed.

The computing device 10 may contain the necessary software application for the investment learning system 1, which inputs the user account information into an algorithm or series of algorithms, as discussed above, such that the data display module 140 can present a digital graphic, graphics, animation, or animations, to display on the screen of the device.

The data display module 140 utilizes information from the user contribution selections module 120, the time frame module 125, the data aggregator module 130, and the graphical conversion module 135. With such information known, the processor will then be caused to display the appropriate graphic, including negative or positive feedback as appropriate during the simulation and may provide a counter graphic that adjusts during the course of the simulation and represents the changes in value of the account as the compound interest formula of the simulation is run (using the data from the graphical conversion module 135). The displayed graphics may include one or more special features that are intended to make the user aware of losses, such as through negative feedback comments or graphics, as discussed above, and further provide encouragement to the user, to reinforce the learning of a long term investment strategy, with continued, ongoing periodic contributions to the account. In an embodiment, the graphic display may be accompanied by a sound or audible commentary, such as may be provided by the software electing to play an audio file associated with the graphics displayed. For example, negative feedback may be accompanied by a sad trombone sounder, or other sound as appropriate, and upon achieving positive growth, or achieving a milestone amount in the account (e.g., $1,000,000), the system may play a celebratory fanfare, fireworks, or crowd applause to provide affirmation for the user's progress toward the milestone.

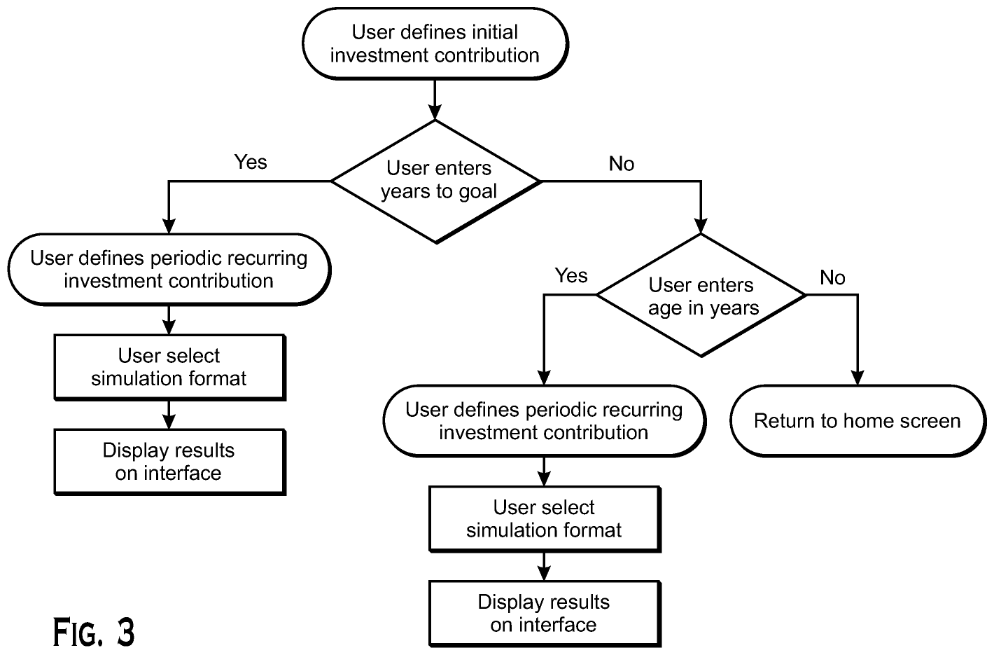

An exemplary process flow for the method of practicing the teachings herein is depicted with reference to FIG. 3. Further details and alternative possibilities to the process flow can be understood with reference to the figure. By way of summary of one example process, the user opens the application to begin using the investment learning system 1. The user begins by providing a numerical value entry that represents the amount of initial contribution to the account being simulated. The user then is to provide an entry as a numerical value that allows determination of the duration of years being simulated, such as by entering an amount of years for the user until retirement or other goal. Alternately, the user may provide a numerical value of the user's age, from which the system may calculate the duration of the simulation until the user reaches a determined retirement age, such as 70 years; in which case the simulation would be the difference of 70 years and the user's age entered. With the duration of the simulation having been determined, the user then to provide a numerical value representing the amount of each recurring periodic contribution to the simulated account. With the duration of the simulation known, and the amount for each periodic contribution know, the system is able to determine the total amount of contribution, and the timing of each contribution over the course of the simulation. Optionally, the user may then elect the nature of the simulation, whether as a custom stress test, or modeling a historical crisis event, or the default scenario of an initial crisis in the first year, followed by growth of the account at an average annual return for the invested fund type. In an embodiment, the user need only press the calculate icon to trigger the simulation, which may be set to trigger a financial crisis in the first year, followed by average historical returns for the balance of the simulation. During the course of the simulation the results are displayed to the user's display of the computing device, including negative feedback regarding losses due to a financial crisis, and providing encouragement to aid the user in recognizing that market returns will compensate for the initial losses, and subsequently provide the total value of the account at the end of the simulation, along with positive feedback concerning the growth of the simulated account.

With reference to FIGS. 4-7, an exemplary embodiment of the investment learning system 1 will be described by way of illustration of using a general user interface for the computing device. In the shown embodiment, the investment learning system 1 runs selected user options versus known historical return data, such as the S&P 500, to generate simulated financial growth over a selected investment period. In the shown embodiment, the selected user options are date period customization, monetary customization, and overall time period customization.

In the shown embodiment with reference to FIG. 4, the user would first select a starting amount of initial investment during the year one. Next, the user would specify their age starting in the year one. Then, the user would input the monthly contribution they would start in the first year and continue to contribute through the time period of retirement at 70 years of age.

In an embodiment of the invention, the investment learning system 1 intentionally limits the user to three (3) inputs, for simplicity of understanding and maintaining focus, such that the user does not get overwhelmed by options. This simulation can thus be helpful for a wide range of ages, where elementary school children can be introduced to financial investing topics, and see the effects of long-term investment strategies and the importance of ongoing contributions.

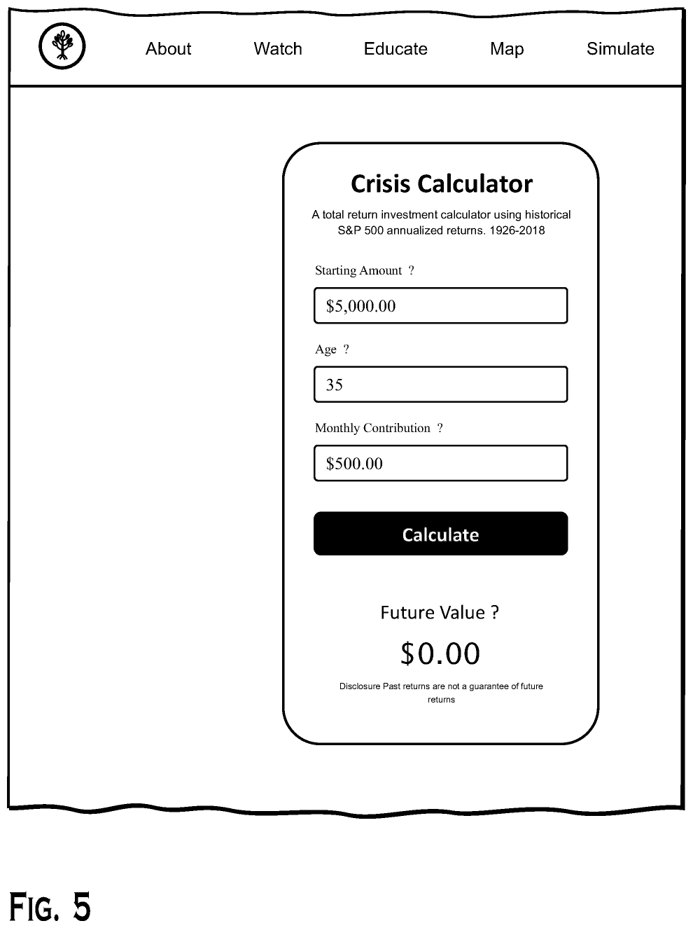

As shown in FIG. 5, in an exemplary embodiment of the investment learning system 1, the user inputs a starting investment amount of $5,000.00, and the selected age of 35 years old, and further inputs a continued expected long term investment plan to deposit $500.00 per month until retirement. This creates simulated scenario conditions wherein the retirement age is 70 years by default and will demonstrate the total investment expectations over the ensuing 35 years.

Further, the investment learning system 1 will simulate investment earnings and losses during the hypothetical timeline and calculate a final hypothetical investment account value at retirement age. For instance, in one embodiment, the investment learning system 1 calculates final hypothetical investment account value through the selection of the calculation icon, which initiates the required calculations by the data aggregator module 130, and converted to graphical form using the graphical conversion module 135, and caused to be displayed on the data display module 140, and may be collectively referred to as the return calculation module. In the depicted embodiment, the simulation utilizes Standard and Poors (“S&P)” 500 annualized return from 1926-2019. This includes earning losses during historical crisis events as well as an estimated drop of return (i.e., 50%) during the first 1-3 years of the investment plan. The return calculation module is activated and runs a return calculation algorithm when the user selects the calculate button icon on the graphical user interface. One skilled the art should appreciate that the return calculation module can be modified to include other historical financial data and events.

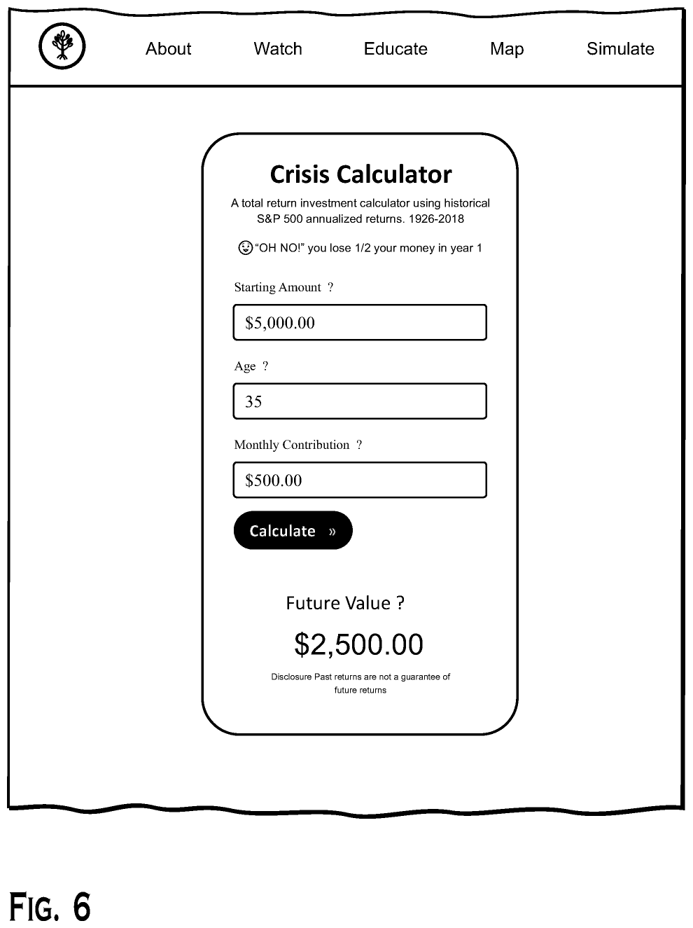

As shown in FIG. 6, when activated, the return calculation module runs the return calculation algorithm that displays earnings and losses in real time and illustrates periods of loss (i.e., flashing red GUI). In an exemplary embodiment, the return calculation module will notify and demonstrate a loss of investment (i.e., 50% loss) and then subsequently show gradual earnings thereafter. For instance, the loss of investment, as a crisis event (i.e., 50% loss of investment), may occur in the first year or within last five years. In another embodiment, the return calculation algorithm randomly selects one or more crisis events to occur any time during investment period.

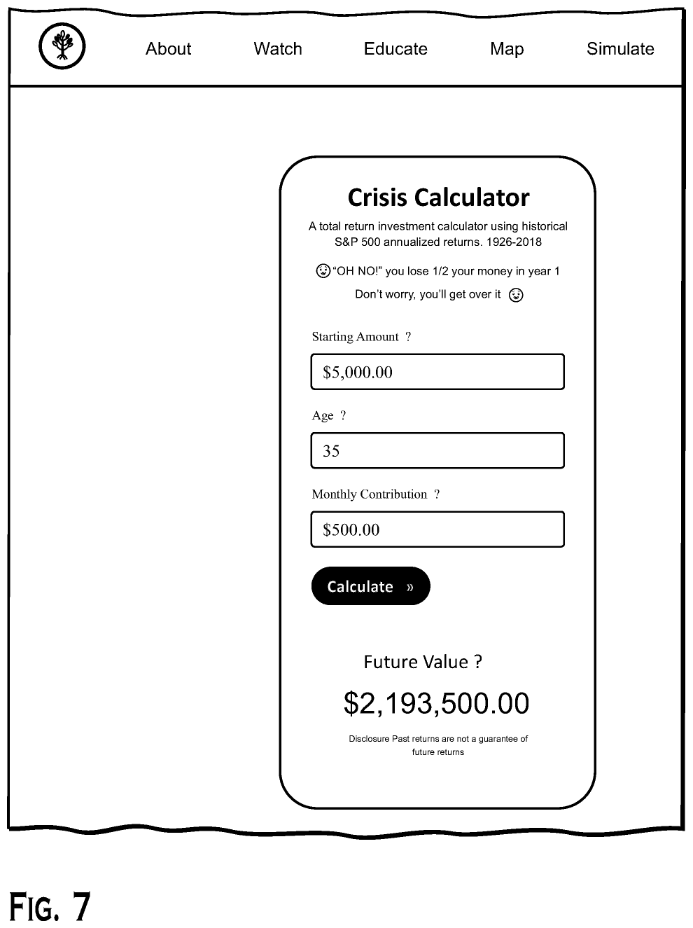

As shown in FIG. 7, the investment learning system 1 will provide a return calculation value based on what the return calculation algorithm runs based on the user inputs and return calculation module defaults. In an exemplary embodiment of the invention, the investment learning system 1 return calculation value may optionally include one or more of the following outputs: an investment return, hypothetical monetary gains, investment statistics (i.e., the number count of up years, the number count of down years, average return, average price to earnings ratio (“P/E”), High P/E, Low P/E, cumulative dividends paid, average dividend yield, high dividend yield, low dividend yield, etc.), a list of top performing companies over the selected time period, and a list companies that were removed from or that went bankrupt over selected time period according to various reporting indices (i.e., S&P 500, Fortune 500, etc.).

In another exemplary embodiment of the invention, the return calculation module would run and then display a value of cumulative dividends paid over a selected time period. In another exemplary embodiment of the invention, the return calculation module would run and then display a return if the user had chosen “not to” reinvest dividends. In another exemplary embodiment of the invention, the return calculation module would run and then display heat map and trend analysis of sector/industry weightings, unemployment over time, or stock market return over a selected period of time.

It is also conceived that the investment learning system 1 will illustrate simulated, continuous returns for each year during a selected time period (i.e. $1 invested in 1929 would be worth x$'s in 1988, $1 invested in 1930 would be worth x$'s in 2015). It is also conceived that the investment learning system 1 will utilize various inputs for selected user options such as date period customization, monetary customization, and overall time period customization. For instance, in an exemplary embodiment of the invention, a user enters actual birthday, and gets actual results based on birthdate and expected or selected age of retirement.

In another exemplary embodiment of the invention, the investment learning system 1 is targeted to provide a visual demonstration of long-term investing, even when faced with adverse short-term conditions that occur frequently over the course of a long term investment term. Accordingly, investment learning system 1 provides educational value to promote long term investment by lay investors, students and young professionals. Further, the investment learning system 1 provides resource for educators and financial adviser to demonstrate the value of long term investment.

It should be understood, that in carrying out the above algorithm, the investment learning system 1 will then display an appropriate object, and animate or provide a graphic representation based on the simulated timeline, including simulated economic crisis. The displayed graphics may include one or more special features that are intended to stimulate investor interest in advancing towards a long term investment goal, and may include congratulatory or encouraging messaging. The graphic may be accompanied by a sound or audible commentary, such as may be provided by the software electing to play an audio file associated with the graphics displayed. For example, upon achieving milestone or rank, the investment learning system 1 may play a celebratory fanfare, fireworks, or crowd applause to provide affirmation for the user's progress toward the milestone.

In the foregoing specification, the invention has been described with reference to specific embodiments thereof. It will be evident, however, that various modifications and changes may be made thereto without departing from the broader spirit and scope of the invention. For example, the reader is to understand that the specific ordering and combination of process actions described herein is merely illustrative, and the invention may appropriately be performed using different or additional process actions, or a different combination or ordering of process actions, including the ability for the user to personalize. Additionally and obviously, features may be added or subtracted as desired. Accordingly, the invention is not to be restricted except in light of the attached claims and their equivalents.

What is claimed is:

1. An investment learning system, comprising:
a single general user interface; and
a computer connected to the single general user interface and having:
a computer readable storage device having a database module for collecting, storing, and linking data associated with historical financial performance data of a market fund;
a central processing unit connected to the single general user interface and the computer readable storage device, and running a plurality of core modules to display a progression of at least one of account values, graphics, audible or text feedback representing the financial performance of a user simulated account through a simulation, the plurality of core modules used to perform the simulation include:
a user contribution selection module for setting an initial amount to invest in the simulated account in numerical value, and a periodic contribution amount to invest in the simulated account in numerical value;
a time frame module configured to set a length of time period represented in the simulation; and
a data display module configured to present a graphical representation of the progression indicative of the financial performance of the simulated account with respect to the initial amount, the periodic contribution amount, and the length of time period.

2. The investment learning system of claim 1, wherein the plurality of core modules further comprises a data aggregator module configured for:
collecting data of the initial amount value;
collecting data of the periodic contribution value; and
collecting data of the length of time of the simulation; and
aggregating the data and applying historical financial performance data to perform the simulation.

3. The investment learning system of claim 2, wherein the plurality of core modules further comprises a graphical conversion module providing a graphical form to display the progression, graphics, or text feedback representing the financial performance of the user simulated account during the simulation.

4. The investment learning system of claim 3, wherein the simulation includes at least one financial crisis event characterized by a negative event in the historical financial performance data for at least a portion of the simulation.

5. The investment learning system of claim 4, wherein the negative event occurs within an initial period of the simulation.

6. The investment learning system of claim 5, wherein the initial period selected from at least one of an initial three simulated years of the simulation.

7. The investment learning system of claim 4, wherein the negative event produces a visual negative feedback in the form a red warning display, a warning sound being audibly detected, and a warning message indicating the negative performance of the account.

8. The investment learning system of claim 7, wherein at least a portion of the progression, graphics, audible or text feedback representing the financial performance of the user simulated account during a simulation includes a positive feedback.

9. The investment learning system of claim 8, wherein the positive feedback includes at least one of displaying green on the display, a celebratory sound being audibly detected, and a congratulatory message concerning the positive performance of the account.
